(19) United States
(12) Patent Application Publication
(10) Pub. No.: US 2005/0149447 A1
(43) Pub. Date: Jul. 7, 2005

(54) Method and apparatus to estimate software charges and analyze computer operating logs

(76) Inventor: Alan M. Sherkow, Whitefish Bay, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/011,395

(22) Filed: Dec. 14, 2004

Related U.S. Application Data
(60) Provisional application No. 60/529,725, filed on Dec. 15, 2003.

(51) Int. Cl. G06F 17/60

(52) U.S. Cl. 705/52

(57) ABSTRACT

A method and apparatus to estimate the software charges in near real time for the use of software products that are executing on a computer system. As a program executes on the computer system, the operating system maintains a history log of each program execution and a history log of the utilization of the computer. These history logs are analyzed to determine which software products are being used and the amount of time the programs are executing. Based on this historic data, interactive reports are created in near real time to analyze the costs of using the software product and modify the usage depending upon various alternative price plans. The alternative price plans and usage information is provided in an interactive report in near real time.

### CROSS REFERENCE TO RELATED APPLICATION

The present application is based on and claims priority from U.S. Provisional Application Ser. No. 60/529,725, filed Dec. 15, 2003.

### BACKGROUND OF THE INVENTION

Much of the software used on mainframe computers, minicomputers, work stations, and personal computers consists of proprietary software licensed from software vendors. Like book publishers, many software vendors retain the copyright on their products, and a software product license usually restricts the licensee's use of the product in several ways.

Software products are usually obtained under a perpetual license, which is equivalent to buying a copy of a book. However, software products are sometimes licensed on a renewable basis, which is equivalent to borrowing a book from a rental library. In either case, the scope of use of the software products is almost always further proscribed.

Software products are often licensed for use only on particular computers, as determined by their serial numbers, or for use on a maximum number of computers, or for use on a maximum aggregate amount of computing power (typically measured in MIPS, millions of instructions per second). Software products may also be licensed only for use by certain named user or by a stipulated maximum number of concurrent users.

Software products may also be licensed based on particular usage metrics, as appropriate for the product in question. For example, a sorting product might be licensed based on how many sort operations the licensee uses it for. Alternatively, software may be licensed based on the number of bytes of data sorted, on the number of records sorted, or on some combination of these factors. A product providing database inquiry capability might be licensed based on the number of inquiries performed, perhaps weighted by the complexity level of each inquiry. A product that performs a number of disparate scientific or engineering calculations might assign a charge-value for each type of calculation and base license fees on the aggregate of these values. Alternatively, the software product may instead simply keep track of the total CPU-time used in performing calculations and base licenses on this value.

Licenses based on usage metrics may be of the “electric meter” type, in which actual usage is measured and paid for by the licensee on a periodic basis (monthly, quarterly, etc.). Licenses may be based on a mutually agreed-to “cap”, such that any amount of usage that does not exceed the cap is covered by a fixed periodic payment, or perhaps by a single initial payment, with additional fees due only if the cap is exceeded in a given measurement period. This latter arrangement is similar to the maintenance contracts on office copiers, which commonly permit no more than, but any amount fewer than, a stated maximum number of copies per month.

With computer software licenses based on usage metrics, the software vendor often incorporates functions and facilities that monitor their license basis, or provides a separate software program that monitors their license basis. Through the software vendors monitoring the usage, amounts are often known to the computer user, but the actual charges for the use of the software are not known until the vendor reviews the monitoring, prepares an invoice and delivers the invoice to the computer user. For example, with IBM's Workload License Charges, there is a 30-day lag between the measurement of the usage in a calendar month and the customer receiving an invoice reflecting that actual usage.

Accordingly, it is an object of the invention to provide a method and apparatus to correlate the use of software products with product's licensing basis and further correlate this information with each product's price plan and provide the computer user an estimate of the software charges in near real-time. A further object of the invention is to allow the user to study a number of alternative pricing plans and licensing bases for the software charges.

A further object of the invention is to provide information to the computer user that assists the user in auditing the software vendor's monitoring of the software product's license basis. The information provided by the method of the present invention is a third-party independent view of each software product's license basis.

### SUMMARY OF THE INVENTION

The method and apparatus of the invention comprises a system for extracting and collecting information about the use of software products and correlating that information with various usage metrics and licenses basis from the computer environment. The information is collected from history logs generated by the computer operating system. The correlation is generally done in small intervals (5 minutes, 15 minutes, 1 hour, etc.), chosen by the computer user but could also occur by the daily, weekly or monthly time period. The collected information is reported in a number of different manners, including “interactive” reports providing the computer user with the ability to do “what-if” modeling of different software product license basis.

More particularly, the apparatus of the invention serves for correlation of software product use with metrics of license basis to estimate the software product charges. The apparatus may (but need not) comprise:

1. One or more user computers with an operating system recording history logs of software product use and computer hardware configuration and other information that may be used for software license basis.

2. An extraction program that processes the history logs and stores a database of software product use. The extraction program also stores a database of computer configuration, utilization and other information that may be used for software license basis.

3. A correlation program to correlate software product use with license basis.

4. A storage program that formats and stores the information for archival use.

Various reporting programs that output local reports including estimation of the software charges for various alternative pricing plans for the software products.

Preferably, the invention includes software facilities for extracting and collecting the information from the history logs. Another software facility serves for correlating the information collected, matching use of software products with utilization or other terms that may be the license basis. Another software facility serves to report on the correlated information. Another software facility stores the information for archival purposes. A further software facility calculates estimated charges for the software products using alternative licensing and pricing plans. Another software facility allows the computer user to define new licensing and pricing plans, adding them to the plans already included in the invention. Another software facility prepares reports for the computer user to assist in software product capacity planning. Another software facility prepares reports for the computer user to assist in computer hardware capacity planning. Another software facility prepares reports for the computer user to audit the monitoring of the software vendors. Another software facility prepares the interactive reports for the computer user.

### BRIEF DESCRIPTION OF THE DRAWINGS

The drawings illustrate the best mode presently contemplated of carrying out the invention.

In the Drawings:

FIG. 1 is a schematic illustration of a prior art IBM Workload License Charge “process” showing the lag before a computer user receives an invoice;

FIG. 2 is an interactive report generated by the present invention illustrating two alternate pricing plans;

FIG. 3 is a block diagram illustrating a computer system for estimating charges for software products using alternative pricing plans and alternative license basis;

FIG. 4 is a flow chart illustrating the flow of an extraction program of the system of FIG. 3;

FIG. 5 is a flow chart illustrating the flow of a correlation program of the system of FIG. 3;

FIG. 6 is a flow chart illustrating the flow of an analysis and reporting group of programs of the system of FIG. 3; and

FIG. 7 is a schematic illustration of an IBM Workload License Charge “process” showing the embodiment of the present invention allowing a computer user to estimate charges prior to invoicing.

### DETAILED DESCRIPTION OF PREFERRED EMBODIMENTS

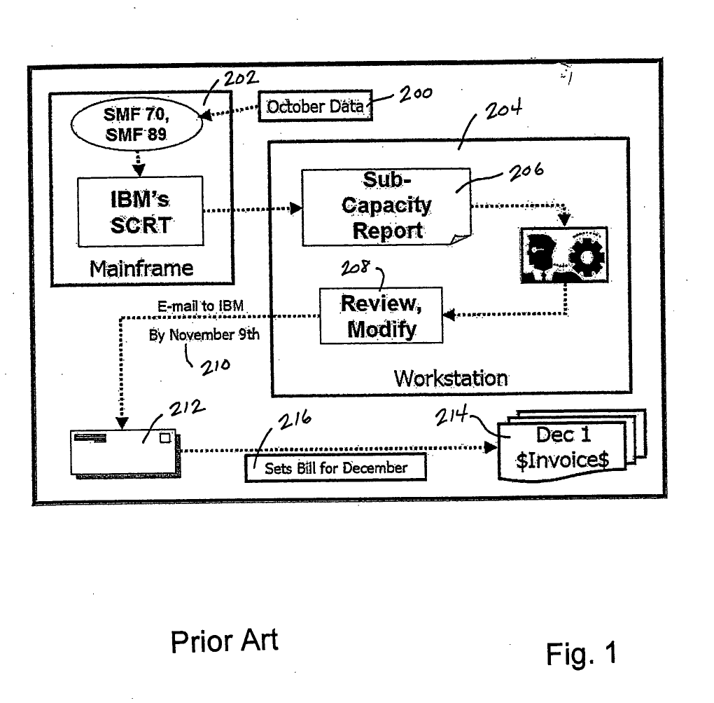

Referring now to FIG. 1, thereshow is the prior art IBM Workload License Charge process. As illustrated in FIG. 1, the currently month's usage data, as represented by block 200, is stored and recorded in the mainframe 202. The mainframe 202 sends the usage information to a work station 204 that creates a subcapacity report 206. The subcapacity report 206 can be reviewed and modified in step 208 and is subsequently emailed to the software vendor, such as IBM. The email to the software vendor typically is sent in the subsequent month following the monitored usage, such as shown by block 210. In the embodiment of the invention illustrated, the October usage data generates an email to the software vendor typically within the next month following the usage of the software product. As illustrated, the October data is forwarded to the software vendor sometime in November.

As illustrated in FIG. 1, the software vendor mails a bill, as illustrated by letter 212, that includes an invoice 214. Typically, the mailed invoices 214 are sent and are due in the next calendar month 216. Thus, the user of the software product may not actually realize the cost of the software usage until one month following the actual usage. In the embodiment illustrated in FIG. 1, the cost of the usage in October is not actually known by the user until the end of November, possibly December. The lag time between the usage of the computer software product and the knowledge of the actual cost prevents the software product user from tailoring their usage to reduce the cost of using the software.

In accordance with the present invention, the software user is presented with a near real time estimation of the cost for using the software product, as well as being presented with alternate pricing schemes and licensing arrangements that may allow the software product user to adjust their usage or modify their license agreement to one of other desirable and available plans.

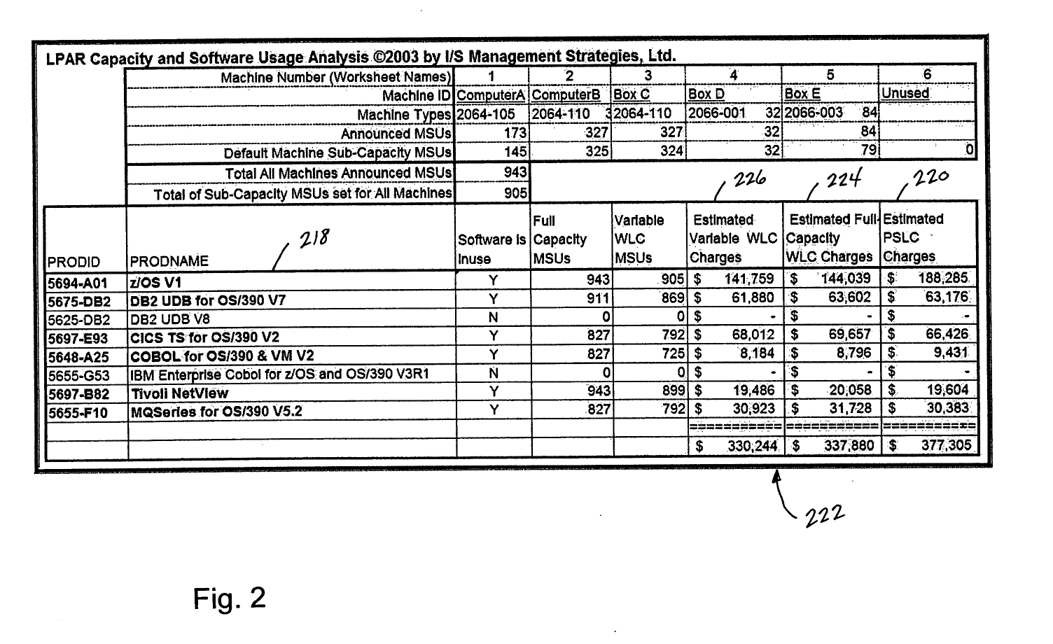

FIG. 2 shows a partial report for one company with six software products 218. This report compares two pricing plans, one named “Parallel Sysplex License Charges” (PSLC) 220 and a second named “Workload License Charges” (WLC) 222. In addition, the report shows that WLC has two separate basis for licensing: Full-Capacity 224 and Variable-Capacity 226. By using the report of FIG. 2, the user can easily compare the alternatives.

The report shown in FIG. 2 is generated in accordance with the present invention and is an interactive report. The computer user can change the actual usage metrics and observe the change in the Estimated Charges. For example, if the “Default Machine Sub-Capacity MSUs” of Machine Number 1 is changed from 145 MSUs to 165 MSUs, the “Estimated Variable WLC Charges” 226 changes from $330,244 to $334,161.

As the report shown in FIG. 2 illustrates, the use of the method and apparatus of the present invention allows a software product user to analyze the current usage of the software product, change variables regarding the usage and determine the cost of the software product based upon the usage changes made. The changes made and reduction in cost are realized by the user in near real time such that the manufacturer can adjust his usage during an individual month without having to wait for a service invoice from the software user.

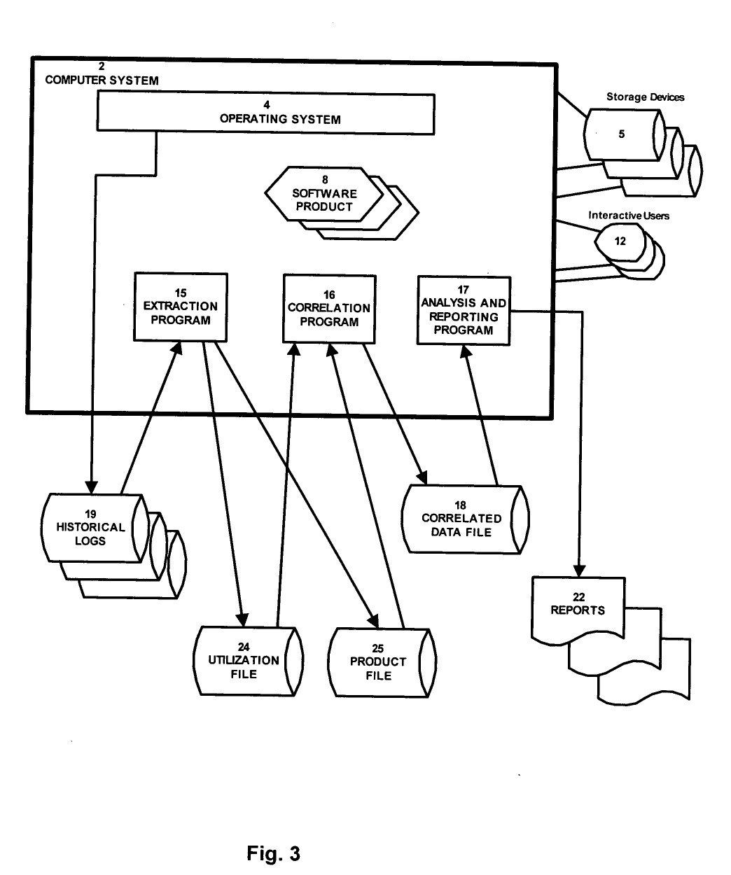

In FIG. 3, the layout of a system for estimating software product charges is described. As is conventional, the computer system 2 includes an operating system 4. As is also conventional, the computer system 2 connects to peripheral devices, examples of which are shown in FIG. 3 and may include storage devices 5 and interactive user terminals 12. Not all of the peripheral devices shown in FIG. 3 are required to be present, and varying computer systems will have differing peripherals. The operating system 4 may contain a number of different services (not illustrated).

As used herein, the term program is used synonymously with executable file. Also as used herein, a “software product”, or “product” is a related group of files comprising at least one program. A product may comprise additional programs and/or non-executable files. As used herein, product generally refers to a particular “version” of a given product.

FIG. 3 comprises a system for estimating the usage charges of software products through analysis of historical logs 19 generated by the operating system 4 of the computer system 2 and stored on a storage device. In the preferred embodiment, the invention includes a computer system having four main components, three of which are executable programs and one of which is an arrangement of information for use by those programs. The four main components are an extraction program 15, a correlation program 16 and an analysis and reporting program 17 for analysis of the data and reporting. The executable programs of the invention are shown using the same underlying user computer as the software products for which prices are being estimated. However, it should be understood that the executable components of the invention could easily operate on a different user computer from the software products being monitored.

The historical logs 19 are generated by the operating system 4 while the operating system is providing various services for the user. The historical logs 19 are a general collection of information that can be used for numerous other purposes beside the use of this information by the invention. The information comprising the historical logs 19 may be stored in a single file or may be stored in multiple separate files and other memory areas. The historical usage information is logged by the operating system 4 as various events occur within the computer system 2 and the usage information is typically formatted into system-related records and job-related records. These historical logs are initially written to system files on the storage devices 5 as they are generated, and are copied to historical logs 19 periodically or when the systems files are full.

The first major component of FIG. 3 is the extraction program 15 that examines the historical logs 19 to extract the information necessary to identify software products in use. Information concerning the types of software product in use is written to the product file 25. The extraction program 15 also extracts the measurements from the historical logs 19 that would be required by any of the possible license basis so that alternative estimates can be calculated by the analysis and reporting program 17. The user of the invention may request the extraction program 15 to perform the extraction from a specific historical log 19 because the user 12 knows the time periods that are recorded on the different historical logs 19.

In the preferred embodiment, the extraction program 15 reads the historical logs 19 record by record and ascertains which records represent which of the software products 8. The manner in which a particular operating system 4 designates any of the records as referencing programs which indicate software products 8 varies. The manner of designating the software products is familiar to persons skilled in the particular operating system 4. As programs are identified in the records and the programs indicate that software products 8 are in use, the usage information is recorded on the product file 25. The extraction program 15 also identifies system-related information that would be required by possible license basis so that alternative estimates can be calculated by the analysis and reporting program 17. This information is written to the utilization file 24.

The second major component of FIG. 3 is the correlation program 16. The correlation program 16 combines information from the product file 25 and the utilization file 24 by a user specified time period, typically an interval of 5, 10 or 15 minutes, which is typically a parameter set by the operating system 4. The combined information from the correlation program 16 is written to the correlated data file 18.

The third major component of FIG. 3 is the analysis and reporting program 17. This program sorts, performs additional correlation, consolidates, summarizes, calculates, formats and generates output reports 22 based upon the information gathered by the other components, specifically the correlated data file 18.

During the generation of the report 22, the analysis and reporting program 17 receives information regarding the type of software product and the usage of the software product from the correlated data file 18. In addition to receiving this information, the analysis and reporting program 17 obtained the pricing the license basis for each of the software products from a stored location. Once the analysis and reporting program 17 has received the required usage information and pricing information, the analysis and reporting program 17 is able to generate the desired report 22.

Some license basis are not directly available for all computer systems 2 or for all operating systems 4. The analysis and reporting program 17 can often compute license basis even if the measurements were not directly in the historical logs 19.

No other method and apparatus has been invented to combine the product, utilization, and software charges together. The system of the present invention provides the user of the invention with immediate information that can be used to make management decisions to control, manage, or reduce the user's software charges.

In the preferred embodiment, the analysis and reporting program 17 can input the correlated data file 18 and other inputs specified by the user 12 and produce a variety of reports 22.

At a typical computer installation, the invention is loaded into the computer system 2 and the extraction program 15 is executed on a periodic basis, most often daily. Each run of the extraction program 15 is followed by a run of the correlation program 16. Once even a small sample of data has been processed, the analysis and reporting program 17 can be run. Some of the reports 22 can be run on a daily basis to assist in capacity planning and managing of the computer environment. Other reports 22 will be run perhaps only monthly, such as the report to audit a vendor's own monitoring of license basis. Still other reports 22, such as the interactive reports, will be used only when the installation wants to perform some “what-if” analysis of the estimation of charges for the software products 5.

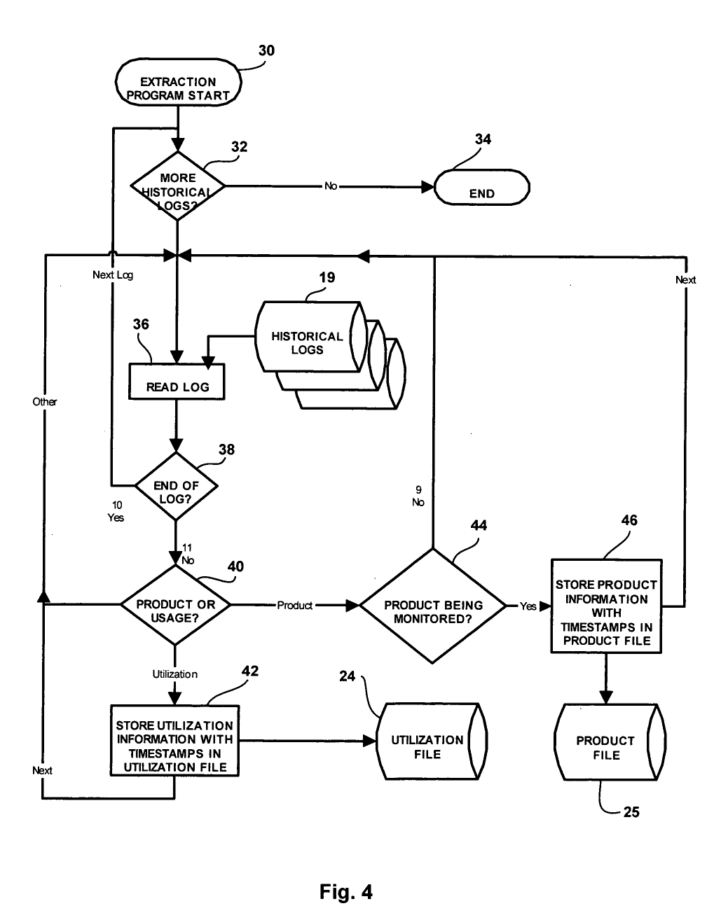

Referring now to FIG. 4, thereshown is a flowchart detailing the steps performed by the extraction program 15 illustrated in FIG. 3. Initially, the extraction program 15 begins operation, as illustrated in step 30. Once the extraction program begins, the program determines whether any additional historical logs are available in step 32. If no additional historical logs are available, the program ends operation, as illustrated in step 34.

However, if additional historical logs 19 are available, the extraction program reads the historical logs 19 in step 36. After each historical log 19 is read in step 36, the program determines if the program has reached the end of the historical log in step 38. If the program has not reached the end of the historical log, the program determines whether the log is related to either product or usage information in step 40. If the program determines that the historical logs relates to utilization information, the utilization information is stored with time stamps in a utilization file 24, as illustrated in step 42. Once the information is stored in the utilization file, the process returns to the reading of the historical logs in step 36.

If, in step 38, the end of the log is reached, the program returns to step 32 to determine whether any additional historical logs exist. This process repeats until the last historical log is reached and the program enters the end step 34.

Returning to step 40, if the historical log includes product information, the program determines whether the historical log includes products that are being monitored, as illustrated in step 44. If it is not a product being monitored, the program returns back to step 36 to further read the historical logs.

However, if the program determines in step 44 that the historical log includes information relating to a software product actually being monitored, the product information, with a time stamp, is stored in the product files 25, as illustrated in step 46. After step 46, the program returns to step 36 to continue to read the historical logs.

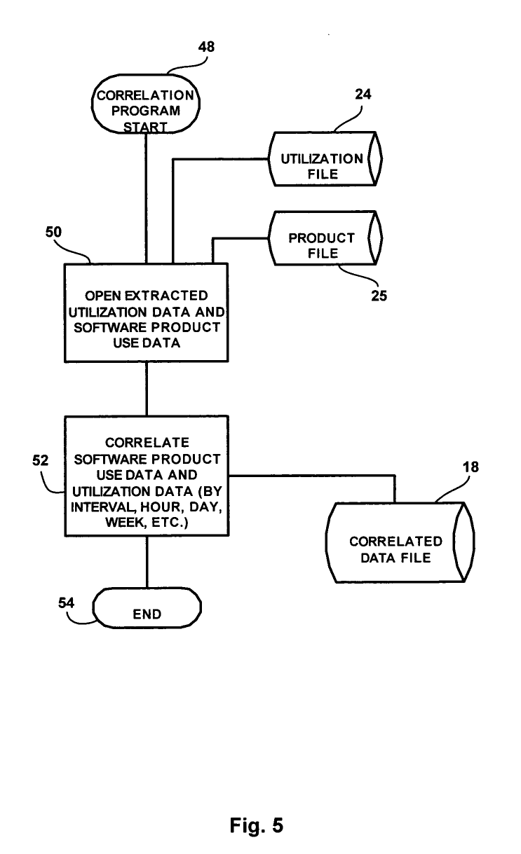

Referring now to FIG. 5, thereshown is the operation of the correlation program 16 shown in FIG. 3. As illustrated, once the extraction program is complete, the correlation program begins at step 48 and initially opens extracted utilization data and software product use data in step 50. This information comes from the utilization file 24 as well as the product file 25.

Once this information is opened, the correlation program correlates the software product and use data in step 52. This correlation can include time frames of either hours, days, weeks, or other values depending upon the user requirements. The correlated information is stored in a correlated data file 18, as illustrated. Once the correlated data files are created and updated, the program ends operation in step 54.

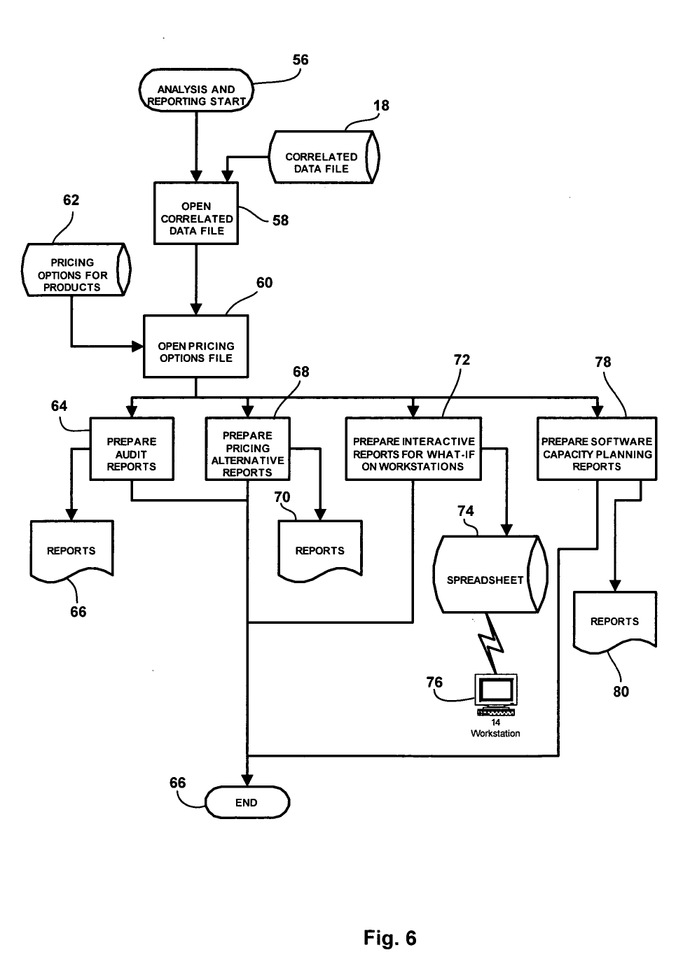

Referring now to FIG. 6, thereshown is the beginning of the analysis and reporting program 17 shown in FIG. 3. As indicated in block 56, the program begins operation and initially opens the correlated data file 18 in step 58. Once the correlated data file is opened, the analysis and reporting program opens a pricing option file in step 60. The pricing option file is stored within the computer program as shown by block 62. The pricing option file includes various pricing information for the software products being licensed. For example, the pricing option file may include pricing information based on the amount of usage of the software product, pricing information based upon different types of license agreements, as well as other pricing information related to the usage of the software product. Typically, the pricing option file 62 is updated on a regular basis such that the pricing option file 62 is generally current for the software products being licensed.

As described above, the pricing option file 62 is updated by either the user or the software vendor on a regular basis such that the pricing option file 62 is current. The user can update the pricing option file 62 either by direct input from the software vendor or the user can define a license in a custom manner. The ability of the user to define the license basis allows the analysis and reporting programs 17 greater flexibility in estimating the cost of usage of the software product.

In accordance with the method of the present invention, once the correlated data file and pricing options have been opened by the computer system, various options are available for the individual user. The first option, as shown in step 64, allows the user to create a report 66 relating the computer software product's actual usage with the pricing information. This report simulates the invoice the user can expect from the software vendor. After this report is created, the analysis and reporting program proceeds to the end step 66.

Alternatively, the analysis and reporting program can prepare a pricing alternative report in step 68. This alternate report is printed in step 70 and provides the user alternate options for controlling computer program usage to preferably minimize the software usage charges.

Another alternative presented by the analysis and reporting program is the preparation of interactive reports for “what if” scenarios on each of the work stations, as illustrated in step 72. These “what if” options are shown in a spreadsheet in step 74 and displayed on a computer work station 76. The “what if” alternatives provide the greatest benefit of the method and operation of the present invention in that they allow the computer user to modify computer configurations and usage to minimize the software charges. As previously described with respect to FIG. 2, the spread sheet shown in FIG. 2 allows the user to vary different usage parameters to see how the change in the usage parameters will affect the licensee. Based upon the interactive spread sheet shown in FIG. 2, the user can then adjust their usage accordingly depending upon the monetary cost for the usage of the software product. As described previously, the spread sheet shown in FIG. 2 allows the user to make usage decisions in a near real time basis to control their monthly usage as desired.

The next alternative operation is the preparation of software capacity planning reports in step 78. These planning reports allow a computer user to predict the cost of operating computer software and adjust the usage based upon various parameters. The software capacity planning reports are printed in block 80 and can be analyzed off line by a computer user.

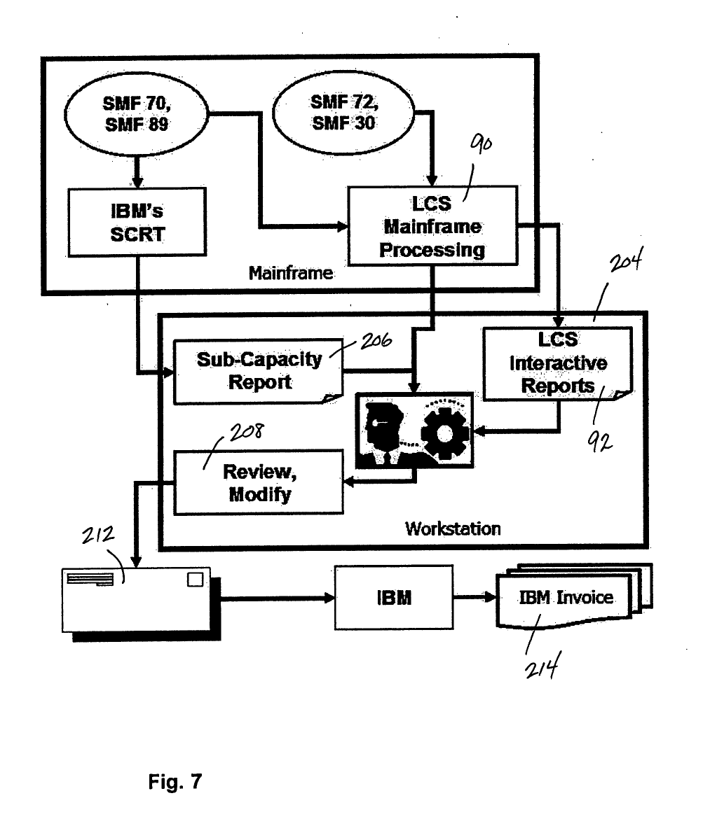

Referring now to FIG. 7, thereshown is the system of the present invention as incorporated with a typical IBM Workload Licensing Charge process. Although the system of the present invention is shown as being utilized with an IBM Work Flow Licensing Charge process, it should be understood that the system of the present invention can be used with many other software product vendors. The usage of the IBM Work Flow Licensing Charge process is used for illustrative purposes only and is not meant to limit the scope of the present invention. As illustrated, the embodiment includes a mainframe processing step 90 that generates an interactive report 92. The interactive reports allow a user to change usage requirements and other features of the mainframe to reduce usage and ultimately the cost of operating numerous programs.

As illustrated in FIG. 7, the work station 204 generates the subcapacity reports 206 and allows the user to review and modify the report as illustrated by block 208. The usage report is still e-mailed to the software vendor who generates, by mail 212, the invoice 214. Although the billing and payment cycle remains the same, the LCS mainframe processing step 90 and the interactive reports 92 allow the user to recognize and realize the software charges on a real time basis prior to receiving the invoice 214.

Various alternatives and embodiments are contemplated as being within the scope of the following claims particularly pointing out and distinctly claiming the subject matter regarded as the invention.

1. An apparatus for estimating software usage charges for a software product in near real time based on various license basis offered by a software vendor, the apparatus comprising:
a computer system that executes the software product and an operating system that creates a historical log of job-related information, the computer system including:
a. an extraction program that reads the historical log to determine if the software product is in use and the license basis alternatives available for the software program;
b. a correlation program to combine the software product usage information and the license basis information; and
c. an analysis and reporting program for generating a plurality of reports detailing the estimated software charges in near real time.

2. The apparatus of claim 1 wherein the computer system includes a software facility for extracting and collection the information from the history log.

3. The apparatus of claim 1 wherein the computer system matches the use of the software product with the license basis.

4. The apparatus of claim 1 wherein the analysis and reporting program calculates estimated charges for the software products using alternative licensing and pricing plans

5. The apparatus of claim 1 wherein the computer system allows new licensing and pricing plans to be defined and added to the plans already included in the computer system.

6. The apparatus of claim 4 wherein the analysis and reporting program prepares interactive reports for the computer user.

7. A method of estimating software usage charges of a software product provided by a software vendor, the method comprising the steps of:
generating a history log regarding the usage of the software product in near real time;
extracting the software product usage information from the history log and at least one license basis for the software product;
correlating the software product usage information with the licensed basis for the software product; and
generating a cost report in near real time to estimate the cost of usage of the software product over a selected time frame based upon the license basis.

8. The method of claim 7 wherein a plurality of distinct license basis for the software product are correlated with the software product usage information.

9. The method of claim 8 wherein the cost report calculates the cost of usage of the software product based on each of the plurality of license basis.

10. The method of claim 7 wherein the cost report is an interactive report such that the software product usage information can be modified by the user and the cost of usage is estimated based on the modified information.

11. The method of claim 9 wherein the cost report simultaneously presents the cost of usage based on each of the plurality of license basis.

12. The method of claim 11 wherein the cost report is an interactive report such that the software product usage information can be modified by the user and the cost of use is calculated based on the modified information.

13. A method of estimating software usage charges of a software product in near real time, the method comprising the steps of:
determining the level of usage of the software product over a measurement period;
correlating the software product usage information with a plurality of license basis for the software product;
generating a cost report in near real time including the software usage charges for the measurement period for each of the plurality of license basis.

14. The method of claim 13 further comprising the step of storing the plurality of license basis in a computer system such that the license basis can be correlated with the software product usage information.

15. The method of claim 13 further comprising the steps of:
modified the software usage information in the cost report; and
generating a modified cost report to estimate the modified software usage charges for the measurement period for each of the plurality of license basis.
